(19) United States
(12) Patent Application Publication
(10) Pub. No.: US 2014/0138538 A1
(43) Pub. Date: May 22, 2014

(54) RESOLUTION AND MASS RANGE PERFORMANCE IN DISTANCE-OF-FLIGHT MASS SPECTROMETRY WITH A MULTICHANNEL FOCAL-PLANE CAMERA DETECTOR

(71) Applicants: Gary M. Hieftje, Bloomington, IN (US); Christie George Enke, Placitas, MN (US); Alexander W. Graham, Bloomington, IN (US); Steven J. Ray, Bloomington, IN (US); Elise Dennis, Bloomington, IN (US); Charles J. Barinaga, Richland, WA (US); David W. Koppenaal, Richland, WA (US)

(72) Inventors: Gary M. Hieftje, Bloomington, IN (US); Christie George Enke, Placitas, MN (US); Alexander W. Graham, Bloomington, IN (US); Steven J. Ray, Bloomington, IN (US); Elise Dennis, Bloomington, IN (US); Charles J. Barinaga, Richland, WA (US); David W. Koppenaal, Richland, WA (US)

(73) Assignees: BATTELLE MEMORIAL INSTITUTE; INDIANA UNIVERSITY RESEARCH AND TECHNOLOGY CORPORATION, Indianapolis, IN (US)

(21) Appl. No.: 14/110,998

(22) PCT Filed: Apr. 16, 2012
(86) PCT No.: PCT/US12/33761

§ 371 Date: Feb. 6, 2014

Related U.S. Application Data
(60) Provisional application No. 61/475,404, filed on Apr. 14, 2011.

(51) Int. Cl. H01J 49/34

(52) U.S. Cl. CPC H01J 49/34
USPC 250/282; 250/286

(57) ABSTRACT

A distance-of-flight mass spectrometer (DOFMS) includes an ion source, a field-free region, an extraction region in which ions are accelerated, and a spatially-selective detector for spatially selectively detecting ions extracted by the extraction region. A method for operating a distance-of-flight mass spectrometer DOFMS comprises controlling a detection time in such a way as to permit ions with progressively greater mass-to-charge (m/z) ratios to enter the extraction region of the DOFMS at positions which will permit the ions with progressively greater m/z ratios to enter the detector of the DOFMS, generating a component mass spectrum at each selected value of detection time, and then assembling a composite mass spectrum by shifting the distance-of-flight axis of each component mass spectrum by a distance corresponding to the change in detection time.

This application claims the benefit under 35 U.S.C. §119(e) of the Apr. 14, 2011 filing date of U.S. Ser. No. 61/475,404. The disclosure of U.S. Ser. No. 61/475,404 is hereby incorporated herein by reference.

### GOVERNMENT RIGHTS

This invention was made with government support under DE-AC05-76RL01830 and DE-FG02-98ER14890 awarded by the Department of Energy and CHE-0822114 awarded by the National Science Foundation. The U.S. Government has certain rights in the invention.

Velocity-based mass separations, such as distance-of-flight mass spectrometry (hereinafter sometimes DOFMS) and time-of-flight mass spectrometry (hereinafter sometimes TOFMS), offer a number of benefits over other mass spectrometry (hereinafter sometimes MS) techniques. For example, DOFMS and TOFMS offer a theoretically unlimited mass range, high spectral generation rates, simultaneous ion-packet analysis, and simple instrument design. See, for example, Enke, C. G., The Unique Capabilities of Time-of-Flight Mass Analyzers. In Adv. Mass Spectrom., Elsevier Science Publishers B. V.: Amsterdam, 1998; Vol. 14, pp 197-219, the disclosure of which is hereby incorporated herein by reference. See also, U.S. Pat. Nos. 7,041,968 and 7,429,728, the disclosures of which are hereby incorporated herein by reference.

TOFMS thus discriminates between ions of different mass-to-charge ratios (hereinafter sometimes m/z) by accelerating ions to mass-dependent velocities and measuring ion flight times at a fixed distance. DOFMS thus holds flight time constant and measures flight distance. Thus, TOFMS provides temporal mass separation, and DOFMS provides spatial mass separation.

Several advantages arise from separating ions in space rather than time. First, DOFMS eliminates the need for TOFMS's fast ion detectors and time-discrimination electronics. Second, DOFMS provides a platform for the incorporation of high dynamic-range, charge-detection arrays into velocity-based mass spectrometers. Third, spatial m/z separation offers the potential for simultaneous isolation and collection of ions of interest.

Of note, two studies of DOFMS have been reported. The first outlines the theoretical framework behind DOFMS. See, Enke, C. G.; Dobson, G. S., Achievement of Energy Focus for Distance-of-Flight Mass Spectrometry with Constant Momentum Acceleration and an Ion Mirror. Anal. Chem. 2007, 79 (22), 8650-8661, the disclosure of which is hereby incorporated herein by reference. The second provides initial results from the first DOFMS instrument. See, Graham, A.; Ray, S.; Enke, C.; Barinaga, C.; Koppenaal, D.; Hieftje, G., First Distance-of-Flight Instrument: Opening a New Paradigm in Mass Spectrometry. J. Am. Soc. Mass. Spectrom. 2011, 22 (1), 110-117, the disclosure of which is hereby incorporated herein by reference. These initial studies provide theoretical and experimental verification of the DOFMS method and also report in detail the operation of the instrument. This application extends DOFMS through the incorporation of a solid state array detector.

According to an aspect of the invention, a distance-of-flight mass spectrometer (DOFMS) includes an ion source, a field-free region, an extraction region in which ions are accelerated, and a spatially-selective detector for spatially selectively detecting ions extracted by the extraction region.

Illustratively according to this aspect, the extraction region comprises two parallel electrodes oriented along a mass-separation axis, and a high-magnitude potential pulse generator for applying a pulsed electric field to the ions to deflect the ions onto the detector.

Illustratively according to this aspect, the detector comprises a respective first amplifier associated with each respective Faraday strip. Each first amplifier includes a capacitance in circuit with the first amplifier to form a respective integrator.

Illustratively according to this aspect, the detector further comprises a respective second amplifier associated with each respective integrator and a computer for controlling the respective second amplifiers to sample the charges resulting from impingement of charged ions onto the respective Faraday strips and hold the charges resulting from impingement of charged ions onto the respective Faraday strips for a time.

Illustratively according to this aspect, the detector comprises a focal plane camera. The active area of the focal plane camera extends along the mass-separation axis of the DOFMS. The focal plane of the camera is positioned at the space-focus plane of the DOFMS during distance-of-flight mass spectrometry.

Further illustratively according to this aspect, the detector comprises a structure providing an extraction orifice positioned between the extraction region and the focal plane of the camera. The structure around the orifice is maintained at about ground potential.

Further illustratively according to this aspect, the apparatus comprises a chiller mounted in heat conducting relationship with the focal plane camera.

Further illustratively according to this aspect, the apparatus comprises a fluid circuit coupled to the chiller and to a source of refrigerant for circulating refrigerant through the fluid circuit for carrying heat away from the chiller.

Further illustratively according to this aspect, the apparatus comprises an ion mirror. The detector collects ions reflected from the ion mirror.

Illustratively according to this aspect, the extraction region comprises a constant-momentum acceleration (CMA) extraction region in which ions are accelerated.

Illustratively according to this aspect, the spatially-selective detector for spatially selectively detecting ions extracted by the extraction region comprises a linear array of discrete charge-collecting Faraday strips for collecting ions extracted by the extraction region.

According to another aspect of the invention, a method for operating a DOFMS comprises controlling a detection time in such a way as to permit ions with progressively greater mass-to-charge (m/z) values to enter the extraction region of the DOFMS at positions which will permit the ions with progressively greater m/z values to enter the detector of the DOFMS. The method further comprises generating a component mass spectrum at each selected value of detection time, and then assembling a composite mass spectrum by shifting the distance-of-flight axis of each component mass spectrum by a distance corresponding to the change in detection time.

According to another aspect of the invention, a method for operating a DOFMS comprises sequentially bringing ions of various m/z values onto the detector of the DOFMS at respective energy-focus times that result in focusing the respective ions at the detector.

Illustratively according to this aspect, sequentially bringing ions of various m/z values onto the detector of the DOFMS at respective energy-focus times that result in focusing the respective ions at the detector comprises providing CMA of the ions, providing in the DOFMS an ion mirror, changing the ion-mirror operating potential (V_{M}) and the DOFMS's distance-of-flight (DOF) detection time (t_{det}) at a set ratio, and detecting unique, m/z-specific energy-focus times.

Further illustratively according to this aspect, the method comprises combining the thus-obtained m/z spectra on a common m/z axis.

The invention may best be understood by referring to the following detailed description and accompanying drawings which illustrate the invention. In the drawings:

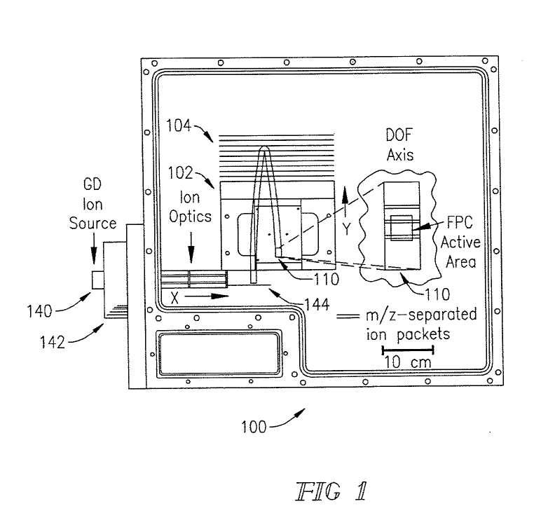

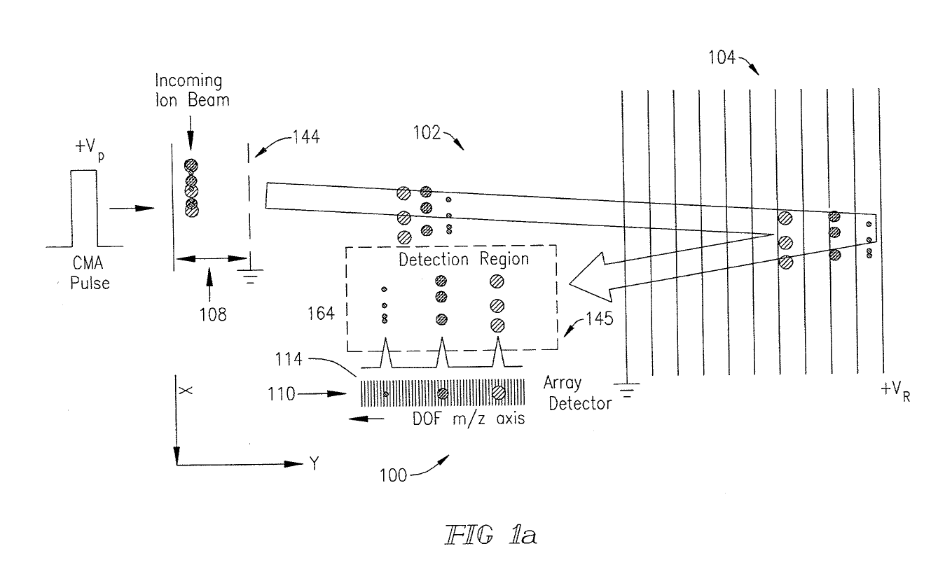

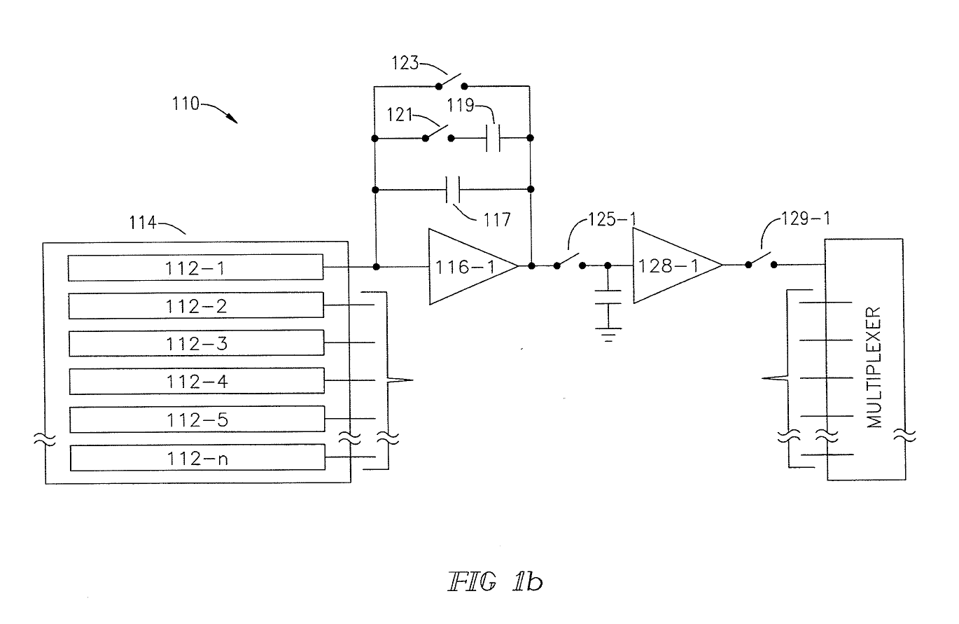

FIGS. 1 and 1a illustrates schematic diagrams of a DOFMS instrument showing an ion flight path, and FIG. 1b illustrates a schematic diagram of the DOFMS detector. In FIGS. 1 and 1a, the x-axis is the initial ion-beam axis, while mass separation occurs along the y-axis. The focal-plane camera (hereinafter sometimes FPC) is positioned at the distance-of-flight (hereinafter sometimes DOF) extraction region, extending collinearly with the mass-separation axis. The enlarged region in FIG. 1 illustrates the FPC's size compared to typical DOF separation between various m/z values.

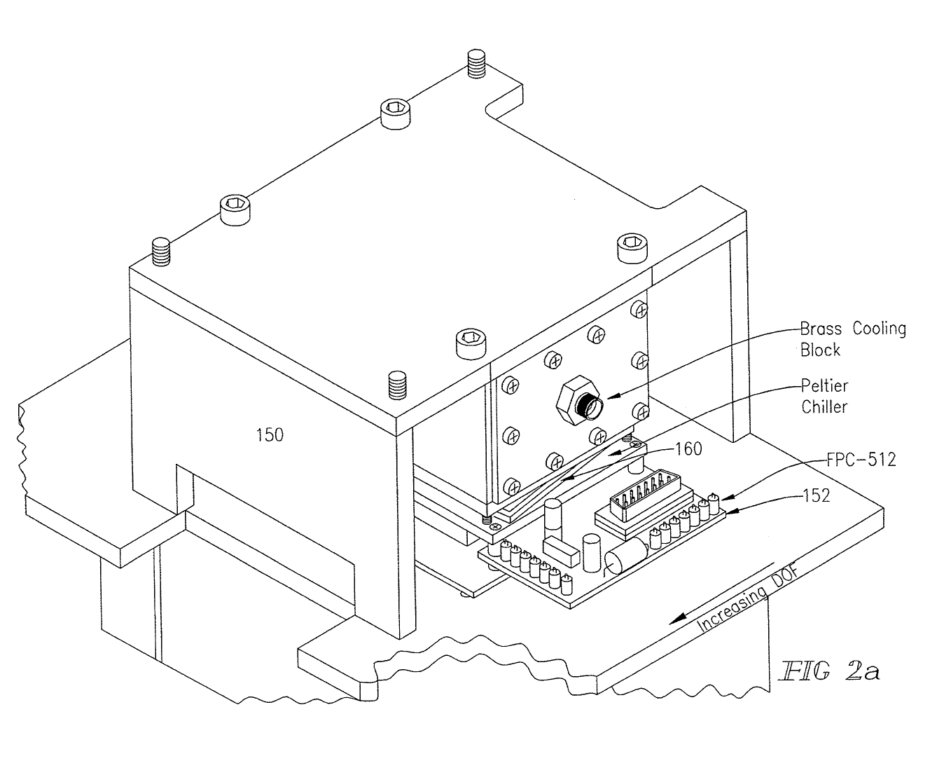

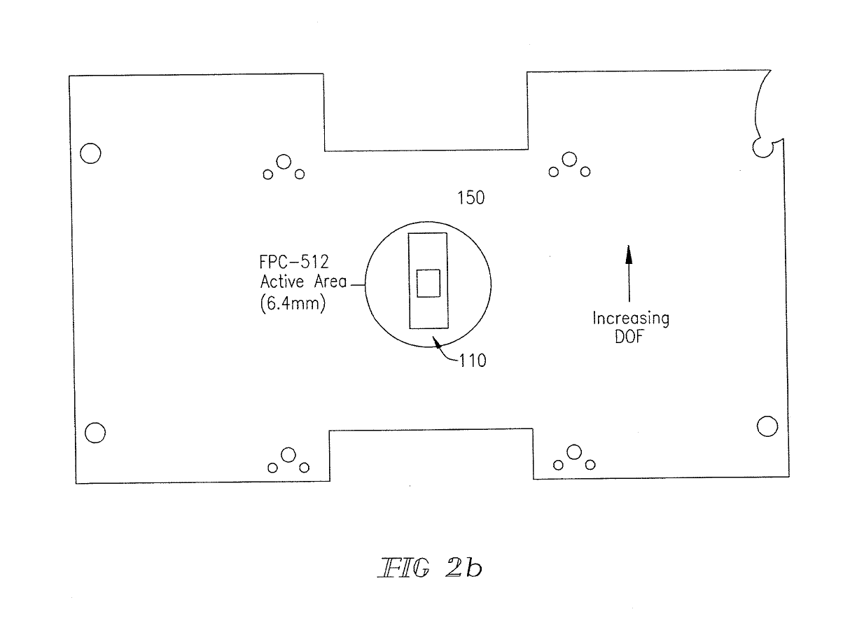

FIGS. 2a-c illustrate the FPC installation on a DOFMS instrument. In FIG. 2a, the FPC is attached to a mounting apparatus that positions the camera along the DOF field-free region. In FIG. 2a, mass separation occurs along the y-axis and the DOF extraction pulse pushes ions upward along the z-axis. In FIG. 2b, the bottom view of the FPC mounting apparatus illustrates the FPC active area. The z-axis is into the plane of FIG. 2b. In FIG. 2c, inside the DOFMS instrument mass-analysis chamber, the camera is installed at a field-free distance of 281.4 mm.

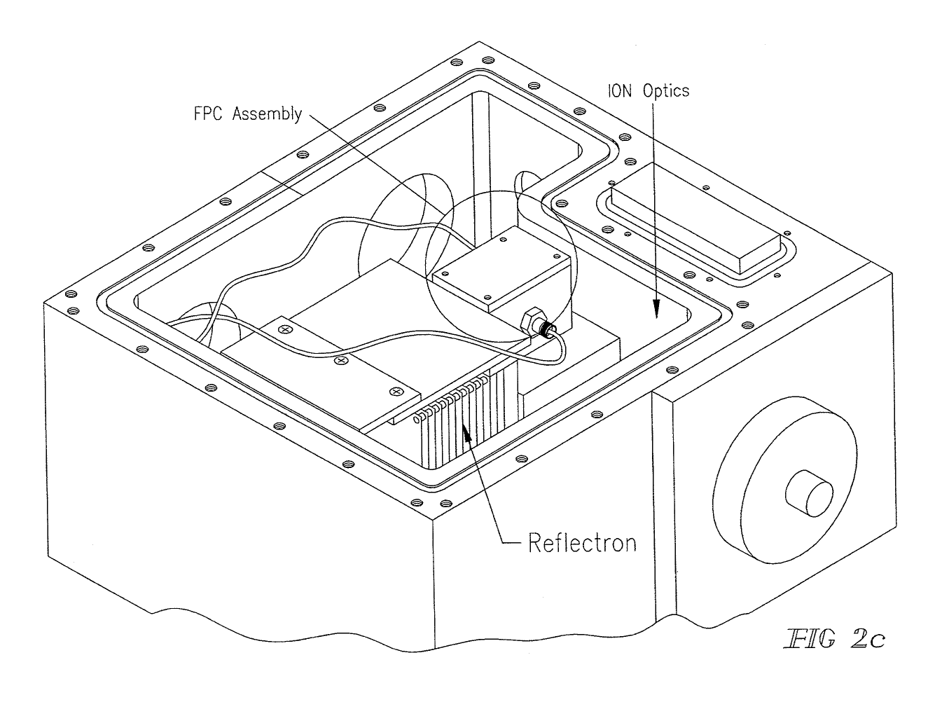

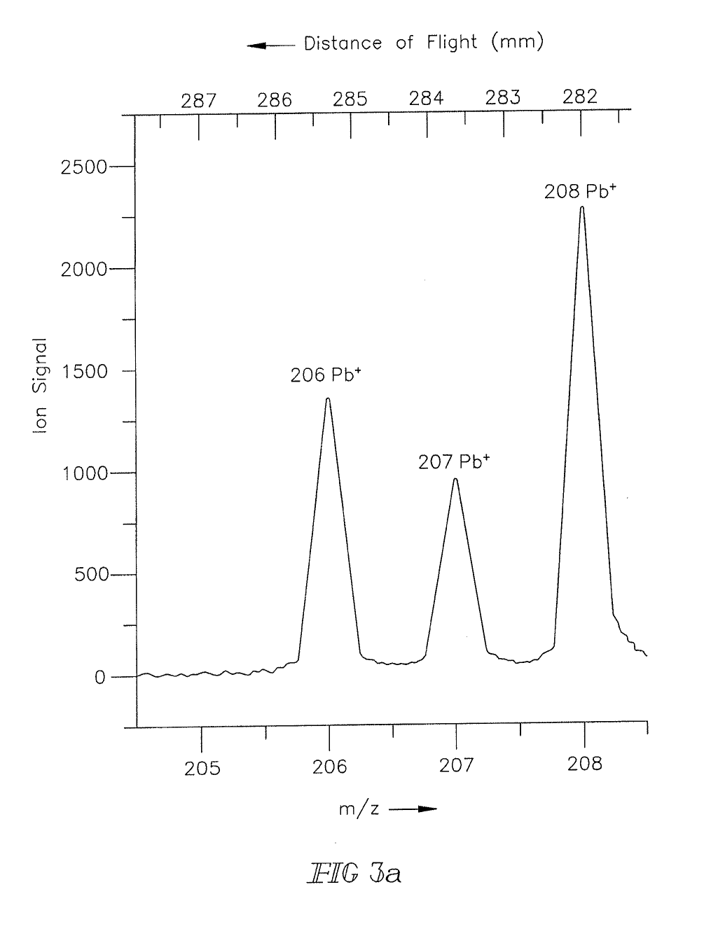

FIGS. 3a-b illustrate DOFMS mass spectra of lead isotopes obtained with (FIG. 3a) the FPC, and (FIG. 3b) a microchannel-plate (hereinafter sometimes MCP)/phosphor detector.

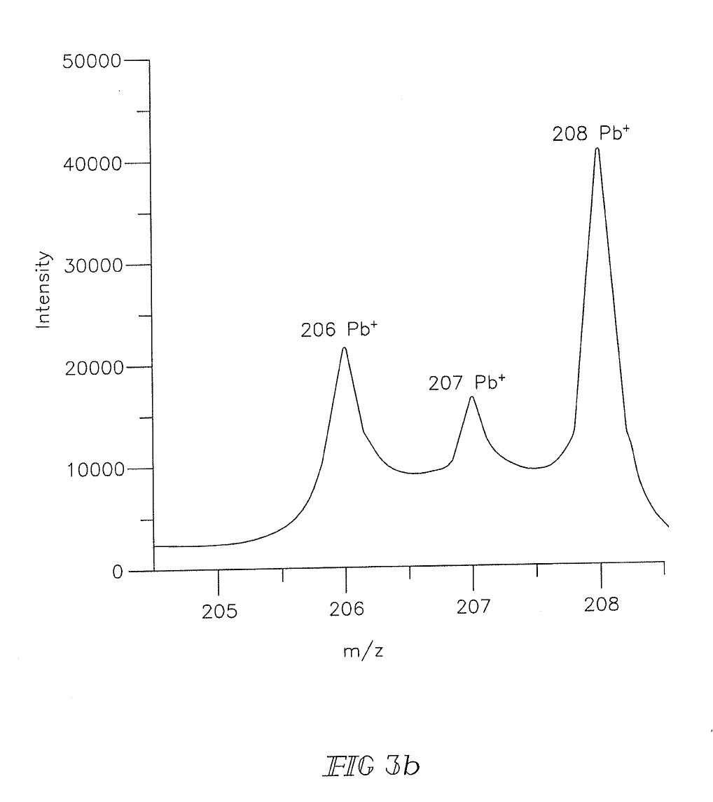

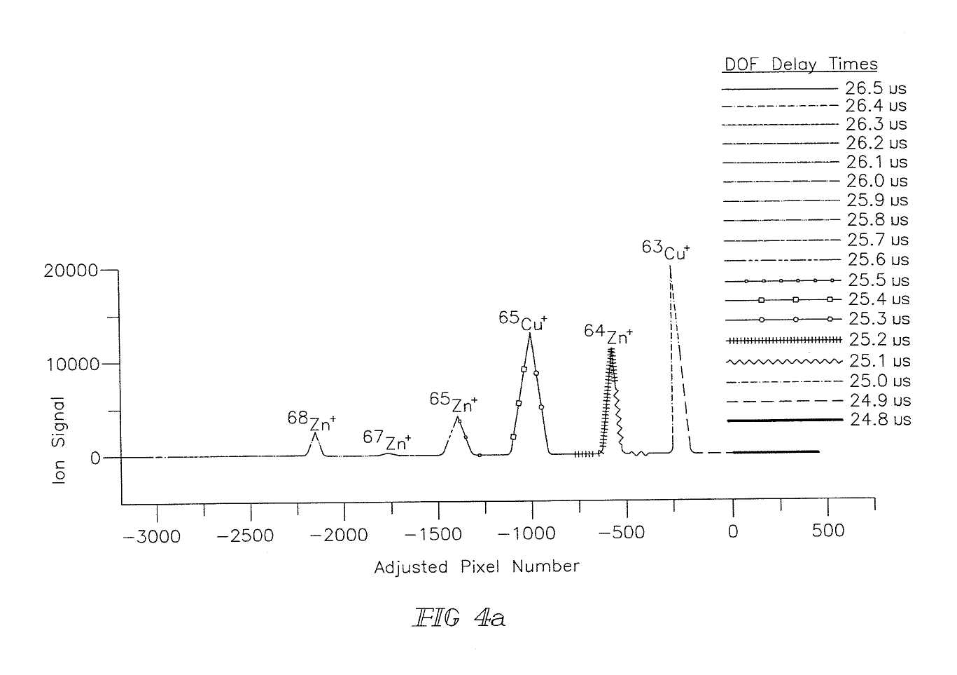

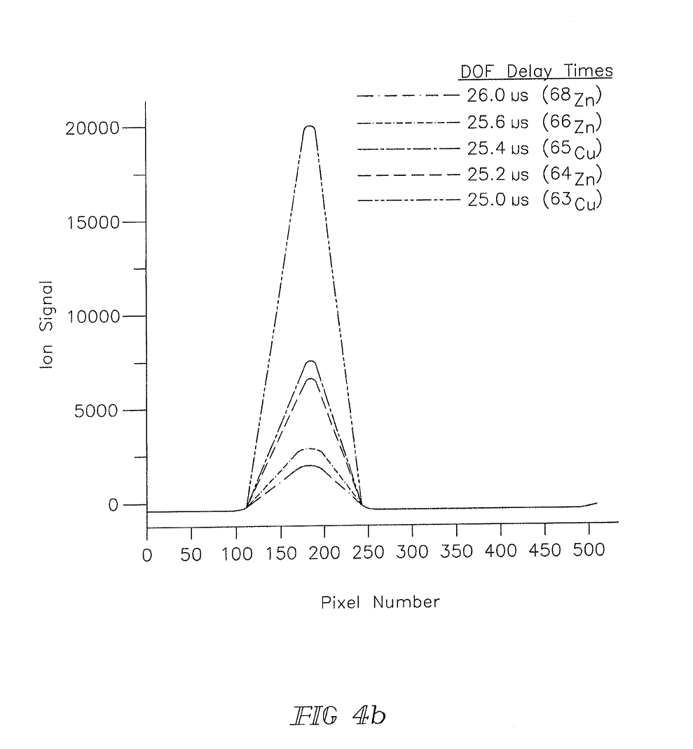

FIGS. 4a-c illustrate (FIG. 4a) a pixel-shifted spectrum of copper and zinc isotopes illustrating the representative isotopic distribution. Individual spectra were recorded at 0.1-0 intervals from a detection time (hereinafter sometimes t_{det})=24.8-26.5 μs. In order to create a composite spectrum, the average velocity of ⁶³Cu⁺ was determined. Each DOF mass spectrum collected at successive DOF delay times was shifted by the number of pixels ⁶³Cu⁺ travels in 0.1 μs. FIG. 4b illustrates DOF mass spectra collected at five different DOF delay times corresponding to five of the Cu and Zn isotopes. Because these mass-separated ion packets strike the FPC at the same position along the array, the resolution achieved cannot be a function of the detector, but rather of DOFMS focusing. FIG. 4c illustrates the best focus achieved with t_{det}=25.0 μs. As this delay time changes and other m/z come into the DOF detection window, resolution degrades.

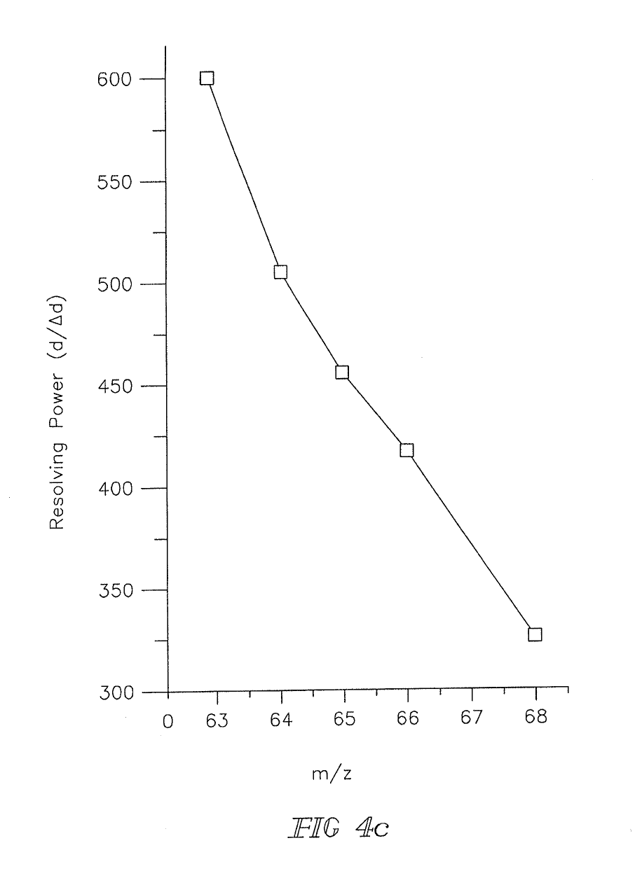

FIG. 5 illustrates how, with constant-momentum acceleration (hereinafter sometimes CMA), the ion-mirror voltage (V_{M}) can be changed to bring ions of any m/z value of interest to the DOF detection distance (hereinafter sometimes L) at the energy-focus time (hereinafter sometimes t_{ef}). The plots in FIG. 5 relate V_{M} and t_{ef} to m/z for a CMA pulse of +400 V and 0.75 μs. The intersection of a vertical line across the stacked plots gives the appropriate V_{M} and t_{ef} for a particular m/z.

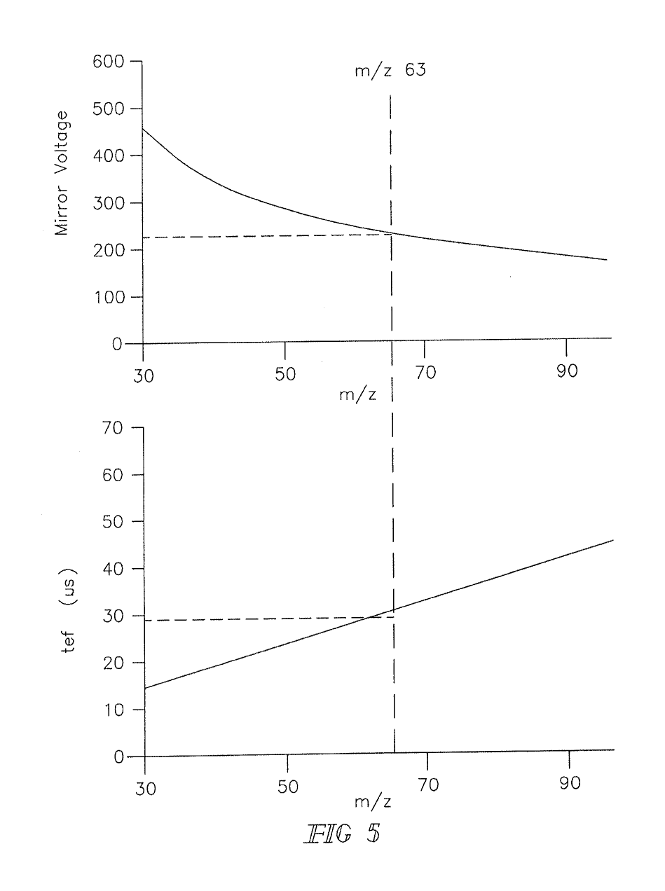

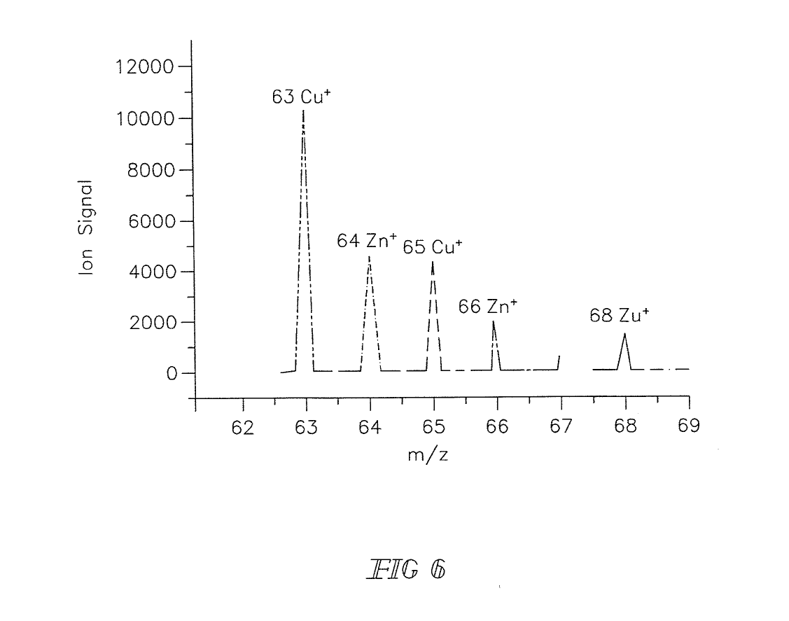

FIG. 6. illustrates five independent, energy-focused mass spectra of the copper and zinc isotopes in a composite mass spectrum. Consistent resolution across all m/z is achieved with the described energy-focused mass-range switching method.

Referring now to the drawings, FIGS. 1, 1a and 1b illustrate schematically a DOFMS 100 constructed according to the invention. In DOFMS 100, ions are accelerated to constant energy, as is normally done with TOFMS, or to a constant momentum, as described below, allowed to drift through a field-free region 102, turned around in a linear-field ion mirror 104, and, while traversing the field-free region 102, are pushed normal to the drift plane at a given detection time t_{det} onto the surface of a spatially selective detector 110. Detector 110 measures the combined field-free flight distance, L, traveled by m/z-separated ion packets during a constant time interval, t.

Consider the relationship between m/z and DOF, which is equivalent to L, in the absence of an ion mirror 104. The m/z-dependent velocity is produced by CMA. CMA is achieved by application of a time-dependent linear acceleration field that is brief enough so that all ions of interest are still within the extraction region at the cessation of the pulse. See, for example, Wolff, M. M.; Stephens, W. E., A Pulsed Mass Spectrometer with Time Dispersion. Rev. Sci. Instrum. 1953, 24 (8), 616-617, the disclosure of which is hereby incorporated herein by reference. CMA is then derivable from fundamental principles:

The force, F, experienced by an ion in the extraction region 108 is given in equation 1:

F=qE_{P}=ma=mdv/dt (1)

where q is the charge (either positive or negative) carried by the ion, E_{P} is the electric-field strength in the extraction region 108, m is the ion mass, and dv/dt is the change in ion velocity with time, the ion's acceleration. In CMA, all ions experience the same force for the same time interval. Solving equation 1 for dt and integrating shows that all m/z are given the same momentum mv:

mv=qE_{P}τ (2)

where v is the ion's final velocity and τ is the pulse length of the applied CMA field. From equation 2, the field-free distance L ions traverse after the end of the CMA pulse during a given ion flight time t can be determined. This shows that DOF is inversely proportional to m/z, that is:

m/z=(1/L)qE_{P}τt (3)

Equations 2 and 3 assume that all ions start with zero initial velocity along the mass-separation axis. However, with any gaseous ion source there is a spread of initial ion velocities. With CMA, these initial velocities are superimposed on velocities attributable to the CMA pulse. These initial velocities would otherwise lead to variations in flight distance and a corresponding spread in peak widths and degradation of resolving power. DOFMSs typically employ a single-stage ion mirror 104 to correct for this initial velocity spread. The ion mirror 104 serves as an energy-focusing device. That is, ions with an initial velocity component toward the mass-separation axis of the DOFMS 100 penetrate deeper into, and spend more time in, the ion mirror 104 than ions with no initial velocity or with a velocity opposing CMA extraction. When ions emerge from the mirror 104, there exists a time at which ions that were initially forward-moving, stationary, or rearward-moving within the CMA source all come into spatial focus. This time is known as the energy-focus time, t_{ef}, Enke, C. G., The Unique Capabilities of Time-of-Flight Mass Analyzers. In Adv. Mass Spectrom., supra. This time t_{ef} is defined by instrumental parameters:

t_{ef}=4E_{P}τ/E_{M} (4)

where E_{M} is the electric field strength in the ion mirror 104. The energy-focus time is valid for all m/z because the time spent in the mirror 104 is a function of only ion energy and not m/z. Additionally, errors caused by turn-around time do not exist in constant momentum DOFMS 100. Because t_{ef} includes the time ions spend in the mirror 104, the relationship between m/z and L is redefined for detection at t_{ef}, namely:

m/z=(1/L)(2q(τE_{P})²/E_{M}) (5)

Equation 5 illustrates several important points about DOFMS 100. First, flight distance provides an unequivocal measure of m/z if a position-sensitive ion detector 110 simultaneously records ions of many m/z values across its surface. Second, since any real DOF detector 110 must be of finite length and is likely to sit at a fixed location, various m/z-windows can be focused onto its surface by simple manipulation of electrical potentials. For example, changing E_{M}, E_{P}, or τ will bring different mass ranges into focus at a stationary DOF detector 110. In this manner, a full mass spectrum can be acquired by sequentially collecting such m/z-windows. Alternatively, desired sections of the spectrum can be rapidly accessed by hopping between windows. Finally, the inverse relationship between m/z and L means that the measurement of mass resolving power R can be accomplished by taking the derivative of Equation 5, which yields:

R=m/Δm=L/ΔL (6)

Though establishment of the energy-focus time provides a theoretical basis for performing DOFMS analysis, implementation of DOFMS also requires a suitable spatially selective detector 110 to discriminate the locations of ion strikes along the mass separation axis. Properties of the DOF detector 110 directly affect mass-spectral resolution, accessible mass range, limits of detection, dynamic range, and simplicity and speed of spectral acquisition. Accordingly, important characteristics for DOFMS detectors include spatial resolution, active detection area, sensitivity, linear dynamic range, simultaneous detection capability, and readout time.

Among the most fundamental requirements for DOFMS detection is spatial selectivity. Several potentially appropriate ion detectors have been developed for use with sector field mass spectrometers or imaging mass spectrometers. See, thr example, Barnes, J. H.; Hieftje, G. M., Recent advances in detector-array technology for mass spectrometry. Int. J. Mass Spectrom. 2004, 238 (1), 33-46; and, Koppenaal, D. W.; Barinaga, C. J.; Denton, M. B.; Sperline, R. P.; Hieftje, G. M.; Schilling, G. D.; Andrade, F. J.; Barnes, J. H.; Iv, I. V., MS Detectors. Anal. Chem. 2005, 77 (21), 418 A-427 A, the disclosures of both of which are hereby incorporated herein by reference. Examples include photographic plates (see, for example, Hannay, N. B.; Ahearn, A. J., Mass Spectrographic Analysis of Solids. Anal. Chem. 1954, 26 (6), 1056-1058, the disclosure of which is hereby incorporated herein by reference), electro-optic imaging detectors (hereinafter sometimes EOIDs) (see, for example, Beynon, J. H.; Jones, D. O.; Cooks, R. G., Imaging detector for mass spectrometry. Anal. Chem. 1975, 47 (11), 1734-1738; and, Giffin, C. E.; Boettger, H. G.; Norris, D. D., An electro-optical detector for focal plane mass spectrometers. International Journal of Mass Spectrometry and Ion Physics 1974, 15 (4), 437-449, the disclosures of both of which are hereby incorporated herein by reference), resistive-anode detectors (see, for example, Aberth, W., An imaging detector system for mass spectrometry. International Journal of Mass Spectrometry and Ion Physics 1981, 37 (3), 379-382, the disclosure of which is hereby incorporated herein by reference), delay-line detectors (see, for example, Froesch, M.; Luxembourg, S. L.; Verheijde, D.; Heeren, R. M. A., Imaging mass spectrometry using a delay-line detector. Eur. J. Mass Spectrom. 2010, 16 (1), 35-45, the disclosure of which is hereby incorporated herein by reference) and discrete-anode array detectors (see, for example, Birkinshaw, K., Fundamentals of Focal Plane Detectors. J. Mass Spectrom. 1997, 32 (8), 795-806, the disclosure of which is hereby incorporated herein by reference). Unfortunately, each of these detection approaches has drawbacks that limit its usefulness for DOFMS detection. For instance, resistive anode or delay-line detectors often provide excellent spatial resolution, but do so through the use of algorithms that necessitate a single ion strike per acquisition period; for DOFMS, ions of multiple m/z must be detected simultaneously across the length of the detector. EOIDs provide simultaneous, two-dimensional ion detection with acceptable resolution, but are subject to peak broadening and lateral signal variation across the MCP/phosphor assembly.

To avoid these shortcomings, an FPC 110 is employed in DOFMS detection. An FPC 110 is a solid-state ion detector comprising a linear array of discrete charge-collecting Faraday strips 112. Originally, the FPC was designed to be oriented along the focal plane of a Mattauch-Herzog mass spectrograph (hereinafter sometimes MHMS). See, for example, Burgoyne, T. W.; Hieftje, G. M.; Hites, R. A., Design and performance of a plasma-source mass spectrograph. J. Am. Soc. Mass. Spectrom. 1997, 8 (4), 307-318; and, Knight, A. K.; Sperline, R. P.; Hieftje, G. M.; Young, E.; Barinaga, C. J.; Koppenaal, D. W.; Denton, M. B., The development of a micro-Faraday array for ion detection. Int. J. Mass spectrom. 2002, 215 (1-3), 131-139, the disclosures of both of which are hereby incorporated herein by reference. See also, U.S. Pat. No. 7,498,585 and WO 2011/140040 the disclosures of both of which are hereby incorporated herein by reference.

Because the MHMS simultaneously disperses ions in space according to m/z, the detector requirements are similar to those of DOFMS. The described FPC has 512 Faraday strips 112. (It is here noted that a 1696-Faraday strip FPC is currently being evaluated for use with DOFMS.) See, for example: Barnes; Sperline, R.; Denton, M. B.; Barinaga, C. J.; Koppenaal, D.; Young, E. T.; Hieftje, G. M., Characterization of a Focal Plane Camera Fitted to a Mattauch Herzog Geometry Mass Spectrograph. 1. Use with a Glow-Discharge Source. Anal. Chem. 2002, 74 (20), 5327-5332; Barnes; Schilling, G. D.; Sperline, R.; Denton, M. B.; Young, E. T.; Barinaga, C. J.; Koppenaal, D. W.; Hieftje, G. M., Characterization of a Focal Plane Camera Fitted to a Mattauch Herzog Geometry Mass Spectrograph. 2. Use with an Inductively Coupled Plasma. Anal. Chem. 2004, 76 (9), 2531-2536; Schilling, G. D.; Andrade, F. J.; Barnes; Sperline, R. P.; Denton, M. B.; Barinaga, C. J.; Koppenaal, D. W.; Hieftje, G. M., Characterization of a Second-Generation Focal-Plane Camera Coupled to an Inductively Coupled Plasma Mattauch Herzog Geometry Mass Spectrograph. Anal. Chem. 2006, 78 (13), 4319-4325; Schilling, G. D.; Ray, S. J.; Rubinshtein, A. A.; Felton, J. A.; Sperline, R. P.; Denton, M. B.; Barinaga, C. J.; Koppenaal, D. W.; Hieftje, G. M., Evaluation of a 512-Channel Faraday-Strip Array Detector Coupled to an Inductively Coupled Plasma Mattauch Herzog Mass Spectrograph. Anal. Chem. 2009, 81 (13), 5467-5473; and, Felton, J. A.; Schilling, G. D.; Ray, S. J.; Sperline, R. P.; Denton, M. B.; Barinaga, C. J.; Koppenaal, D. W.; Hieftje, G. M., Evaluation of a fourth-generation focal plane camera for use in pasma-source mass spectrometry. J. Anal. At. Spectrom. Accepted Manuscript, the disclosures of all of which are hereby incorporated herein by reference.

A number of features make the FPC 110 well suited for DOFMS detection. In the illustrated embodiment, the FPC 110 employs 512 charge-collecting Faraday strips 112 that are each 8.5-μm wide at a pitch of 12.5 μm. This geometry results in a 6.4-mm-long array 114 with 68% of the array 114 being ion-active. Each Faraday strip 112-n has a dedicated integrating amplifier 116-n with two levels of gain, controlled by the capacitance in its negative feedback loop. At high gain in which a, for example 8 fF, capacitor 117 is coupled across an input terminal and an output terminal of dedicated integrating amplifier 116-n (1≦n≦512), the FPC 110 has a limit of detection of about 100 charges, although improvements in detection limits (that is, to reduce the detection limit to smaller numbers of charges) are currently contemplated, owing to developments in both detectors and detection methods. In a lower gain configuration, a, for example 8 μF, capacitor 119 is coupled in parallel with the 8 fF capacitor 117 by closing a computer-operated switch 121, increasing the capacitance across the input and output terminals of amplifier 116-n, reducing the gain. A computer-operated switch 123 is in parallel with each pair of capacitors to discharge it/them before the beginning of the next data acquisition cycle. Because the FPC 110 is flat and measures the ion flux directly, it provides a direct electrical readout of mass-separated ion-packet widths and the number of ions in each packet. The FPC 110 produces analog signals proportional only to ion charge, eliminating the effect of detector mass bias while providing signal enhancement for multiply-charged ions.

The FPC 110 also offers truly simultaneous detection by gating the output signals from all integrating amplifiers 116-n through respective computer-operated switches 125-n into respective sample-and-hold amplifiers 128-n before readout from the sample-and-hold amplifiers 128-n via respective computer-controlled switches 129-n on a shift register. Gating and readout are computer-controlled and can be integrated into the DOF timing system. Currently, the FPC 110 has a software-limited data acquisition rate of 10 Hz, making its spectrum-acquisition rate compatible with many chromatographic systems. See, for example, Barnes, J. H.; Schilling, G. D.; Sperline, R. P.; Denton, M. B.; Young, E. T.; Barinaga, C. J.; Koppenaal, D. W.; Hieftje, G. M., Coupling of a gas chromatograph to a simultaneous-detection inductively coupled plasma mass spectrograph for speciation of organohalide and organometallic compounds, supra. Experimentally, a dynamic range greater than 10⁸ has been reported for the described FPC 110, surpassing what is currently available for TOFMS detection. Schilling, G. D.; Ray, S. J.; Rubinshtein, A. A.; Felton, J. A.; Sperline, R. P.; Denton, M. B.; Barinaga, C. J.; Koppenaal, D. W.; Hieftje, G. M., Evaluation of a 512-Channel Faraday-Strip Array Detector Coupled to an Inductively Coupled Plasma Mattauch Herzog Mass Spectrograph, supra. Extended dynamic range detection is especially critical for complex-mixture analysis, where the dynamic range of current methods has been shown to limit the number of detectable compounds. Enke, C. G.; Nagels, L. J., Undetected Components in Natural Mixtures How Many? What Concentrations? Do They Account for Chemical Noise? What Is Needed to Detect Them?, supra. Reported isotope ratio precision better than 0.05% RSD illustrates uniform pixel-to-pixel response across the array. Schilling, G. D.; Ray, S. J.; Rubinshtein, A. A.; Felton, J. A.; Sperline, R. P.; Denton, M. B.; Barinaga, C. J.; Koppenaal, D. W.; Hieftje, G. M., Evaluation of a 512-Channel Faraday-Strip Array Detector Coupled to an Inductively Coupled Plasma Mattauch Herzog Mass Spectrograph, supra. Finally, the modern semiconductor fabrication technologies employed to construct the FPC 110 ensure exceptional device-to-device uniformity and a moderate cost for large-scale production.

One characteristic in which the disclosed FPC 110 falls short is its length. An ideal DOFMS detector would be as long as practical, so that the widest range of m/z values could be detected on each ion extraction. The small size of the described detector 110 is not a fundamental limitation of solid-state detection technology. In fact, a similar detector, 12 cm in length and with 4800 channels, has been described. See, for example, SPECTRO MS Fully Simultaneous ICP-Mass Spectrometer. Ametek Materials Analysis Division: 2011, the disclosure of which is hereby incorporated herein by reference. For reference, with the presently described instrument geometry and a 12-cm detection area, almost the entire lanthanide and actinide series could be detected simultaneously, from ¹⁴¹Ce to ²³⁸U. A compilation of critical DOFMS detector characteristics with a qualitative comparison between the FPC 110 and the known MCP/phosphor detector is provided in Table 1.

TABLE 1
Comparison of Modern Detector Arrays With the Ideal DOF Detector

| | | MCP^{b}/ |
|---|---|---|
| Ideal Characteristic | FPC^{a} | Phosphor |
| Flat, Spatially Selective Detection | + | + |
| Surface | | |
| Simultaneous Detection | + | + |
| Long Active Area | −, [6.4 mm] | 0, [25 mm] |
| Dynamic Range | +, [10⁸] | −, [10³] |
| Sensitivity (down to single ion strike) | 0, [100 charges] | − |
| No Mass Bias | + | − |
| No Detector-Limited Resolution | + | − |
| Uniform Signal Response Along | + | − |
| DOF Axis | | |
| Direct Computer Control | + | − |
| Fast Detection/Readout Time | 0, [100 ms] | − |
| Timing Synchronous with DOF | + | − |
| Separation | | |
| Cost | 0 | + |

^{a}FPC = Focal Plane Camera,
^{b}MCP = MicroChannel Plate; In this evaluation, a plus/0/minus (+, 0, −) ranking system indicates the relative ability of the detection system to satisfy ideal needs of DOFMS detection. For some characteristics, figures of merit are provided in brackets.

The illustrated DOFMS instrument 100 has been previously described, Graham, A.; Ray, S.; Enke, C.; Barinaga, C.; Koppenaal, D.; Hieftje, G., First Distance-of-Flight Instrument: Opening a New Paradigm in Mass Spectrometry, supra., so only a brief description will be provided here. The DOFMS instrument 100 generates singly charged atomic ions with a reduced-pressure, direct-current (DC) glow-discharge (hereinafter sometimes GD) ionization source 140. See, for example, McClenathan, D. M.; Hieftje, G. M., Absolute methods of quantitation in glow discharge mass spectrometry with a time-of-flight mass analyzer. J. Anal. At. Spectrom. 2005, 20 (12), 1326-1331, the disclosure of which is hereby incorporated herein by reference. After analyte ions are cathodically sputtered from a conductive sample, they are transported to the mass analyzer via a three-stage differentially pumped interface 142. Upon entering the third vacuum stage, the ion beam is focused into the CMA extraction region 144 by a DC-quadrupole doublet ion optics train. See, for example, Rogers, D. A.; Ray, S. J.; Hieftje, G. M., An electrospray/inductively coupled plasma dual-source time-of-flight mass spectrometer for rapid metallomic and speciation analysis: instrument design. Metallomics 2009, 1 (1), 67-77; and, Myers, D. P.; Li, G.; Mahoney, P. P.; Hieftje, G. M., An inductively coupled plasma-time-of-flight mass spectrometer for elemental analysis. Part II: Direct current quadrupole lens system for improved performance. J. Am. Soc. Mass. Spectrom. 1995, 6 (5), 400-410, the disclosures of which are hereby incorporated herein by reference

The CMA extraction region 144 comprises two parallel electrodes that are coaxial to the input ion optics. A positive high voltage (HV), square-shaped pulse is applied to the CMA repeller plate, while the gridded, front electrode of the CMA region 144 is held at ground potential. This HV pulse forms a transient electric field that accelerates ions orthogonally to their initial propagation axis.

After CMA extraction, ions traverse grounded, field-free region 102 according to their spontaneous-drift trajectories (see, for example, Guilhaus, M., Spontaneous and deflected drift-trajectories in orthogonal acceleration time-of-flight mass spectrometry. J. Am. Soc. Mass. Spectrom. 1994, 5 (6), 588-595, the disclosure of which is hereby incorporated herein by reference), until they enter the single-stage ion mirror 104. After emerging from the mirror 104, ions return to the grounded field-free region 102 before arrival at the DOF extraction region 145.

The DOF extraction region 145 comprises two parallel electrodes that are in line with the mass-separation axis. At a specific t_{det} delayed from the onset of the CMA pulse, a +3000 V, 2 μs pulse is applied to the DOF repeller plate in order to generate a constant-energy acceleration (hereinafter sometimes CEA) field that pushes m/z-separated ions onto the surface of the FPC 110. The t_{det} pulse is applied just prior to the energy-focus time to account for transit time of ions from the DOF extraction region to the FPC 110. t_{det} is adjusted so that ions strike the FPC 110 surface at t_{ef}. CMA and DOF pulse widths, as well as t_{det}, are controlled by a single commercial pulse generator of the type available from, for example, Berkeley Nucleonics Corporation, San Rafael, Calif., operated remotely with LabVIEW® system design platform and development environment version 8.6, available from National Instruments, Austin, Tex.

FIGS. 2a-c illustrate a detector stand 150 for mounting the FPC 110 in the DOFMS instrument 100. The detector stand 150 includes a circuit board 152 that supports the FPC 100 extending along the mass-separation axis from flight distance 281.4 mm to flight distance 286.8 mm. The detector face of the FPC 110 is positioned at the space-focus plane (see, for example, Cotter, R. J., Time-of-flight Mass Spectrometry. American Chemical Society: Washington D.C., 1994; Vol. 549, the disclosure of which is hereby incorporated herein by reference) of the DOF extraction region 156. To prevent capacitive coupling of the DOF extraction field to the camera 110 electronics, a grounded DOF extraction orifice positioned between the DOF extraction region and the FPC 110 face was limited to 1.75 cm×0.75 cm, with the FPC 110 oriented in the center of the orifice 158.

Johnson noise was limited by cooling the FPC 110 to −45° C. with a Peltier-effect chiller 160 attached in heat-conducting relationship to the back of the circuit board 152, directly behind the FPC 110 integrated circuit. Heat was removed from the hot side of the Peltier element 160 by a 1:1 mixture of ethylene glycol:water maintained at −18° C. by a recirculating chiller such as the Endocal chiller available from Neslab Instruments, Inc., Newington, N.H. and circulated through a brass cooling block fixed directly behind the chiller. UltraTorr® Cajon fittings available from Swaglok, Solon, Ohio supplied the cooling liquid into the DOFMS 100's vacuum chamber 164.

Electrical connections to the FPC 110 were supplied into the vacuum chamber by three hermetically sealed connectors, such as the μD connectors available from Mouser, Mansfield, Tex. Power to the FPC 100 and supporting circuit board was supplied by a model 6603D-10 external 12 V supply available from Topward Electric Instruments Co, Taiwan. The Peltier-effect chiller 160 operated from a model 1621A DC supply available from BK Precision, Yorba Linda, Calif., providing a current limit of approximately 3.25 A and an approximately 10 V operating voltage. The FPC 110 was operated under computer control by, for example, LabVIEW® system design platform and development environment through a National Instruments PCI-6281, 18-bit data acquisition card.

The integration times for all Faraday strips 112 on the FPC 110 are software-controlled. Throughout the integration time, the voltage output at each integrating amplifier 116-1, . . . 116-n is coupled to a respective sample-and-hold amplifier (SaHA) 128-1, . . . 128-n. If ion flux is constant across the entire integration window, charge impinges at a linear rate on each Faraday strip 112-1, . . . 112-n and a plot of acquisition voltage vs. time is a straight line. The slope of this plot, along with the gain level of the integrating amplifier 116-1, . . . 116-n, indicates the flux of charges impinging on a respective Faraday strip 112-1, . . . 112-n. All ion signals reported herein were obtained by this method, although various integration periods were used. Additionally, all DOF spectra were background-subtracted with a spectrum collected at a t_{det} set to an off-mass region (that is, one or more Faraday strips 112-1, . . . 112-n that received no flux from the ion source) of the DOF spectrum and smoothed via LabVIEW® system design platform and development environment, “Savitzky-Golay Filter.vi.”

Resolution for all FPC 110 mass spectra was calculated as L/ΔL (Eq. 6), where L is the m/z flight distance and ΔL is the full-width at half maximum (hereinafter sometimes FWHM) determined from a Gaussian fit to the mass-spectral peak with OriginPro® software, version 8.5, OriginLab Corporation, North Hampton, Mass. Calibration of DOF spectra to a linear m/z scale was accomplished with a linear fit of (m/z)⁻¹ versus DOF.

To test the described system, solid, metallic samples of brass and lead were obtained from the Indiana University Mechanical Instrument Services Department. A metal ingot of tin (National Bureau of Standards, Standard Sample 42d, U.S. Department of Commerce, Washington D.C.) was used for tin isotope determination. All samples were analyzed directly with the GD ionization source 140.

The first experimental implementation of DOFMS, Graham, A.; Ray, S.; Enke, C.; Barinaga, C.; Koppenaal, D.; Hieftje, G., First Distance-of-Flight Instrument: Opening a New Paradigm in Mass Spectrometry, supra., utilized an MCP/phosphor detector assembly and an optical camera to capture images of mass-spectral lines visible on the phosphor plate. This system was cumbersome to operate, required time-consuming image acquisition and off-line processing, and produced convoluted mass spectra due to the various conversion steps in signal amplification and collection. See, for example, Edgar, M. L.; Kessel, R.; Lapington, J. S.; Walton, D. M., Spatial charge cloud distribution of microchannel plates. Rev. Sci. Instrum. 1989, 60 (12), 3673-3680, the disclosure of which is hereby incorporated herein by reference. With the MCP/phosphor detection system, peak widths of 0.6-1 mm and mass resolving powers (R(_{FWHM})) of around 400 were obtained across a mass range from 52-208 amu. Graham, A.; Ray, S.; Enke, C.; Barinaga, C.; Koppenaal, D.; Hieftje, G., First Distance-of-Flight Instrument: Opening a New Paradigm in Mass Spectrometry, supra. However, it was unclear from these initial studies whether the recorded peak widths were fundamental to the DOF mass-separation technique, dictated by the specific DOFMS design, or a product of the detection system. To overcome the shortcomings of the MCP/phosphor setup, the FPC 110 was installed. Since the FPC 110 directly detects charge as ions strike each Faraday strip 112-1, . . . 112-n, the signal from the camera 110 provides a truer representation of DOF peak widths.

FIG. 3 compares a DOF mass spectrum of lead isotopes obtained with the FPC 110 to one acquired with the MCP/phosphor detector. Results with the FPC 110 demonstrate baseline-resolved Pb peaks with linewidths of around 275 μm and R(_{FWHM})=1000, whereas the MCP/phosphor produced linewidths of 1000 μm and R(_{FWHM})=400. This 2.5 times increase in resolving power is attributable to the greater spatial resolution of the FPC 110 because no other instrument modifications discriminate the two spectra. Table 2 lists DOFMS linewidths and resolving powers achieved with the FPC 110 for a number of isotopes across the elemental mass range of the described setup. Differences in resolving power between m/z ranges are minimal and are the result of ion-optic focus achieved in any given experiment. Under the instrumental conditions employed here, 4.6 amu can fit along the FPC 110 in the Pb mass range. Improved resolving power and peak shape apparent with the FPC 110 are the result of direct charge detection and minimal image spreading afforded by the FPC 110.

TABLE 2
DOF Mass Resolving Power Attained With FPC 110

| Isotope | Δd (FWHM) | R (FWHM) |
|---|---|---|
| 40_{Ar} | 300 μm | 900 |
| 63_{Cu} | 250 μm | 1100 |
| 120_{Sn} | 325 μm | 860 |
| 208_{Pb} | 270 μm | 1030 |

Compared to the MCP/phosphor detection assembly, the FPC 110 yielded more highly resolved peak shapes. At linewidths of several hundred μm, enough Faraday strips 112-1, . . . 112-n on the FPC 110 are involved in the data collection to provide reliable peak-shape information. A Gaussian shape is expected because the DOFMS 100 peak should mimic the spatial distribution of ions within the CMA extraction region. A slight tailing toward the high mass, short DOF is also observed and is the result of second-order energy defocusing. See, thr example, Enke, C. G.; Dobson, G. S., Achievement of Energy Focus for Distance-of-Flight Mass Spectrometry with Constant Momentum Acceleration and an Ion Mirror, supra. All peaks obtained with the FPC 110 fit well to a Gaussian function (R²≧0.99), whereas with the MCP/Phosphor, peaks were less Gaussian-like.

In DOFMS, ions of all m/z values that exit the ion mirror, or reflectron, 104 are energy-focused at t_{ef}. However, only ions that are within the DOF detection region at t_{det} and at the field-free lengths covered by the DOF detector 110 after DOF extraction are detectable in a given experiment. The m/z window observable for a particular detector length (L_{D}) and the field-free length at the far (“downstream”) end of the detector 110 (L_{far}) can be calculated as a ratio of the highest m/z observable (m/z)_{high} to the lowest (m/z)_{low}:

(m/z)_{high}/(m/z)_{low}=L_{far}/Lₙₑₐᵣ=1/(1−L_{D}/L) (7)

With the described FPC 110 array 112-1-112-512 positioned at a far field-free distance of 287.8 mm, the high-to-low mass ratio available is 1.023. This ratio corresponds to a mass range of only 4.6 amu when ²⁰⁸Pb+ is the high mass of interest, 2.6 amu for ¹²⁰Sn+, and 1.4 amu for ⁶⁴Zn+. In order to expand the detectable mass range with the FPC 110, two methods have been developed to “scan” a DOF mass spectrum.

The first method, sometimes referred to hereinafter as the “pixel shifting” method, is performed by incrementally changing t_{det} while keeping all other electrical potentials constant. As t_{det} is increased, ions with progressively heavier m/z values come into the DOF extraction region 145 at the correct position to strike the FPC 110. At each selected value of t_{det}, a mass spectrum is recorded. A composite mass spectrum is then assembled by shifting the DOF axis of each component mass spectrum by the appropriate distance for each incremental change of t_{det}. The pixel-shifting method is straightforward and can be easily automated in order to “scan” a broader m/z range with a single DOF detector 110 of limited length. FIG. 4a illustrates a composite spectrum of the copper and zinc isotopes acquired with 17 different DOF delay times and assembled with the pixel-shift method. FIG. 4a clearly illustrates the isotopic distribution of copper and zinc and is displayed with the DOF axis running left to right. The conventional m/z axis would, of course, run right to left.

This pixel-shifting method does, however, have some limitations. With constant CMA and reflectron 104 conditions, true energy focus is achieved for only a single DOF spectrum within the pixel-shifted composite. Resolution degrades as t_{det} moves away from the energy-focused detection time. This point is illustrated in FIG. 4, in which focus was optimized for ⁶³Cu⁺ at t_{det}=25.0 μs. FIG. 4b illustrates overlaid, non-pixel-shifted DOF mass spectra of the copper and zinc isotopes. In FIG. 4c, a plot of the resolving power of these spectra versus m/z illustrates a decline in resolving power as t_{det} moves away from 25.0 μS.

Though the pixel-shift method causes resolution to degrade with t_{det}, loss of resolving power with m/z is not intrinsic to DOFMS. In fact, optimal resolving power along the DOF axis is available for ions of all m/z values at t_{ef}.

In order to take further advantage of the focusing ability of DOFMS, a second mass-scan method was developed in which a composite, or “stitched,” spectrum is generated by sequentially bringing ions of various m/z values onto the detector 110 at their proper energy-focus times. As demonstrated in equations 4 and 5, the t_{ef} and L of a particular m/z are function only of electrical potentials. In particular, if CMA conditions are held constant, changing V_{M} and t_{det} at a set ratio permits DOF detection of many different m/z ranges at several unique, m/z-specific energy-focus times. FIG. 5 illustrates how V_{M} and t_{det} were chosen to bring ions of a particular m/z onto the FPC 110. In order to assemble a complete mass spectrum, each DOF spectrum was independently mass-calibrated and then compiled on a single m/z axis. FIG. 6 provides a stitched mass spectrum of the copper and zinc isotopes obtained in five independent mass windows. Table 3 lists the experimental conditions with calculated values shown parenthetically and the resolving power obtained with this energy-focused mass-scan method. Table 3 verifies that DOFMS 100 is performing as predicted by theory. Resolution does not significantly degrade between mass windows, which indicates that all m/z are energy-focused. Also, the mirror 104 values and detect times that were calculated from theory almost exactly match experimental results without adding any instrumental correction factors.

TABLE 3
Instrumental Conditions and Results for
Energy-Focused Mass-Range Switching

| m/z | Mirror 104 | DOF delay | DOF line Width | Resolving |
|---|---|---|---|---|
| (Th) | Voltage (V_{M}) | Time (μs) | (FWHM) (μm) | Power (d/Δd) |
| 63 | 227.5 | 27.92 | 378 | 750 |
| | (228.3)* | (27.85) | | |
| 64 | 225.9 | 28.47 | 363 | 790 |
| | (224.9) | (28.27) | | |
| 65 | 222.3 | 28.89 | 390 | 730 |
| | (221.6) | (28.70) | | |
| 66 | 218.9 | 29.13 | 402 | 710 |
| | (218.1) | (29.15) | | |
| 68 | 212.8 | 30.03 | 390 | 700 |
| | (212) | (30.00) | | |

*Values listed in parentheses were calculated from fundamental principles to bring each m/z of interest onto the DOF detector at a flight distance of 286 mm.

Implementation of the energy-focused mass-scan method illustrates that a small, stationary DOF detector 110 can be used to rapidly switch among mass ranges. Because this mass-range switching method requires simply changing electrical potentials, detector 110 response and readout times control how quickly different mass windows can be acquired. With the described FPC 110, mass ranges can be switched every 100 ms, provided there is sufficient ion flux. Additionally, substitution of a larger DOF detector 110 enhances the efficiency of this method because larger m/z windows can be acquired at each t_{det}.

Incorporation of the FPC 110 into the DOFMS 100 enhances the utility of DOFMS 100. The results described herein illustrate improved mass resolution. The described methods expand the mass range available for DOF detection. Additionally, recent reports of other spatially selective array detectors underline an expanding level of interest in dispersive MS detection. See, for example, Hadjar, O.; Johnson, G.; Laskin, J.; Kibelka, G.; Shill, S.; Kuhn, K.; Cameron, C.; Kassan, S., IonCCD™ for Direct Position-Sensitive Charged-Particle Detection: from Electrons and keV Ions to Hyperthermal Biomolecular Ions. J. Am. Soc. Mass. Spectrom. 2011, 22 (4), 612-623; and, Bamberger, C.; Renz, U.; Bamberger, A., Digital Imaging Mass Spectrometry. J. Am. Soc. Mass. Spectrom. 2011, 22 (6), 1079-1087, the disclosures of which are hereby incorporated herein by reference.

1. A distance-of-flight mass spectrometer (DOFMS) including an ion source, a field-free region, an extraction region in which ions are accelerated, and a spatially-selective detector for spatially selectively detecting ions extracted by the extraction region.

2. The apparatus of claim 1 wherein the extraction region comprises two parallel electrodes oriented along a mass-separation axis, and a high-magnitude potential pulse generator for applying a pulsed electric field to the ions to deflect the ions onto the detector.

3. The apparatus of claim 1 wherein the detector comprises a plurality of Faraday strips and a respective first amplifier associated with each respective Faraday strip, each first amplifier including a capacitance in circuit with the first amplifier to form a respective integrator.

4. The apparatus of claim 3 wherein the detector further comprises a respective second amplifier associated with each respective integrator and a computer for controlling the respective second amplifiers to sample the charges resulting from impingement of charged ions onto the respective Faraday strips and hold the charges resulting from impingement of charged ions onto the respective Faraday strips for a time.

5. The apparatus of claim 1 wherein the detector comprises a focal plane camera, an active area of which extends along a mass-separation axis of the DOFMS, the focal plane of the camera positioned at a space-focus plane of the DOFMS during distance-of-flight mass spectrometry.

6. The apparatus of claim 5 wherein the detector further comprises a structure providing an extraction orifice positioned between the extraction region and the focal plane of the camera, the structure around the orifice being maintained at about ground potential.

7. The apparatus of claim 5 further comprising a chiller mounted in heat conducting relationship with the focal plane camera.

8. The apparatus of claim 7 further comprising a fluid circuit coupled to the chiller and to a source of refrigerant for circulating refrigerant through the fluid circuit for carrying heat away from the chiller.

9. The apparatus of claim 1 further comprising an ion mirror, the detector collecting ions reflected from the ion mirror.

10. The apparatus of claim 1 wherein the extraction region comprises a constant-momentum acceleration (CMA) extraction region in which ions are accelerated.

11. The apparatus of claim 1 wherein the spatially-selective detector for spatially selectively detecting ions extracted by the extraction region comprises a linear array of discrete charge-collecting Faraday strips for collecting ions extracted by the extraction region.

12. A method for operating a distance-of-flight mass spectrometer (DOFMS) comprising controlling a detection time in such a way as to permit ions with progressively greater mass-to-charge (m/z) values to enter the extraction region of the DOFMS at positions which will permit the ions with progressively greater m/z values to enter the detector of the DOFMS, generating a component mass spectrum at each selected value of detection time, and then assembling a composite mass spectrum by shifting the distance-of-flight axis of each component mass spectrum by a distance corresponding to the change in detection time.

13. A method for operating a distance-of-flight mass spectrometer (DOFMS) comprising sequentially bringing ions of various mass-to-charge (m/z) values onto the detector of the DOFMS at respective energy-focus times that result in focusing the respective ions at the detector.

14. The method of claim 13 wherein sequentially bringing ions of various mass-to-charge (m/z) values onto the detector of the DOFMS at respective energy-focus times that result in focusing the respective ions at the detector comprises providing constant-momentum acceleration (CMA) of the ions, providing in the DOFMS an ion mirror, changing the ion-mirror operating potential (V_{M}) and the DOFMS's distance-of-flight (DOF) detection time (t_{det}) at a set ratio and detecting unique, m/z-specific energy-focus times.

15. The method of claim 13 further comprising combining the thus-obtained m/z spectra on a common m/z axis.

16. The apparatus of claim 2 wherein the detector comprises a plurality of Faraday strips and a respective first amplifier associated with each respective Faraday strip, each first amplifier including a capacitance in circuit with the first amplifier to form a respective integrator.

17. The apparatus of claim 16 wherein the detector further comprises a respective second amplifier associated with each respective integrator and a computer for controlling the respective second amplifiers to sample the charges resulting from impingement of charged ions onto the respective Faraday strips and hold the charges resulting from impingement of charged ions onto the respective Faraday strips for a time.

18. The apparatus of claim 2 wherein the detector comprises a focal plane camera, an active area of which extends along a mass-separation axis of the DOFMS, the focal plane of the camera positioned at a space-focus plane of the DOFMS during distance-of-flight mass spectrometry.

19. The apparatus of claim 18 wherein the detector further comprises a structure providing an extraction orifice positioned between the extraction region and the focal plane of the camera, the structure around the orifice being maintained at about ground potential.

20. The apparatus of claim 18 further comprising a chiller mounted in heat conducting relationship with the focal plane camera.
